(19) United States
(12) Patent Application Publication
(10) Pub. No.: US 2024/0139736 A1
(43) Pub. Date: May 2, 2024

(54) ALL IN ONE SAMPLE SEAL KIT

(71) Applicant: Hipro Biotechnology Co., Hayward, CA (US)

(72) Inventor: Dong HAO, Shijiazhuang (CN)

(73) Assignee: Hipro Biotechnology Co., Hayward, CA (US)

(21) Appl. No.: 18/495,733

(22) Filed: Oct. 26, 2023

(30) Foreign Application Priority Data
Oct. 26, 2022 (CN) 202222833564.6

(51) Int. Cl. B01L 3/00

(52) U.S. Cl. CPC B01L 3/502715; B01L 3/5023; B01L 2200/026; B01L 2200/0689; B01L 2200/16; B01L 2300/069; B01L 2300/0825

(57) ABSTRACT

An integrated sampling sealed reagent box is disclosed. The reagent box includes a testing box, sampling probe, piston cap, and reagent vial. There is a test strip set inside the testing box. The sampling probe is set at the first end of the reagent box. The piston cap has a load-bearing chamber, and a sealing structure is provided at the opening of the load-bearing chamber. The piston cap is sealed and connected to the first end of the testing box through the sealing structure. The reagent vial is located in the bearing chamber and is used to hold testing reagents. The mouth of the reagent vial is lower than the opening of the piston cap. The integrated sampling sealed reagent box fixes the reagent vial in the bearing chamber, the mouth of the reagent vial is lower than the opening of the piston cap, and a sealing structure is set.

### CROSS REFERENCE TO RELATED APPLICATION

This application claims priority to Chinese application no. 202222833564.6 filed on Oct. 26, 2022, which Issued on Feb. 28, 2023 as CN218537538U, the entire disclosure of which is incorporated herein by reference.

### TECHNICAL FIELD

This utility model belongs to the field of reagent testing technology, and more specifically, relates to an integrated sampling sealed reagent box.

### BACKGROUND

A reagent box is a box used to hold chemical reagents for detecting chemical components, drug residues, virus types among others.

In prior art, during the process of reagent testing, when the sampling probe on the testing reagent box penetrates into the reagent box, it will puncture the aluminum film sealed on the testing reagent vial, but the aluminum film is usually sealed on the mouth of the reagent vial. When the aluminum film is sandwiched between the contact surface of the testing reagent box and the testing reagent vial when they come into contact, there may be a problem of poor sealing between the contact part of the testing reagent box and the testing reagent vial, which can cause the escaping gas to drift freely. And during the process of shaking the vial to mix reagent, it can lead to reagent leakage and environmental pollution. Therefore, what is needed is an apparatus that provides an integrated sampling sealed reagent box to solve the problem of poor sealing and easy leakage of reagents.

### SUMMARY

In accordance with various embodiments and aspects of the present disclosure, an integrated sampling sealed reagent box, aiming to solve the problem of poor sealing and easy leakage of reagents. In order to achieve the above objectives, the technical solution adopted by this utility model is to provide an integrated sampling sealed reagent box, which includes:

A testing box, internally equipped with a test strip;

A sampling probe, arranged at the first end of the reagent box, including a main body part and a flow guide groove arranged on the main body part, and the flow guide groove is arranged along the length direction of the main body part;

A piston cap with a load-bearing chamber and a sealing structure at the opening of the load-bearing chamber, wherein the piston cap is sealed and connected to the first end of the testing box through the sealing structure; and

A reagent vial, located in the carrying cavity for containing testing reagents, is sealed with an aluminum film at the vial mouth, which is lower than the opening of the piston cap.

In accordance with various embodiments and aspects of the present disclosure, the inner wall of the load-bearing chamber is provided with a fixing structure, and the reagent vial is clamped inside the piston cap through the fixing structure.

In accordance with various embodiments and aspects of the present disclosure, the fixing structure comprises multiple grooves arranged inside the bearing chamber, and the outer wall of the reagent vial body is uniformly fixed in a circular shape with fixing blocks. After the reagent vial is installed, the fixing blocks rest against the inside of the grooves.

In accordance with various embodiments and aspects of the present disclosure, the interior of the bearing chamber is further provided with multiple auxiliary ribs, all of which are arranged along the depth direction of the piston cap. The multiple auxiliary ribs are arranged in a circular shape on the inner wall of the bearing chamber, and the two adjacent auxiliary ribs are spaced between each other. The grooves correspond to the auxiliary ribs one by one and are all located on the side of the auxiliary ribs.

In accordance with various embodiments and aspects of the present disclosure, the end of the auxiliary ribs near the piston cap opening is provided with a guide slope, and at least three auxiliary ribs are provided.

In accordance with various embodiments and aspects of the present disclosure, the other end of the auxiliary ribs is also provided with a positioning convex block, which is located on the side of the auxiliary rib and extends towards the center of the bearing chamber. Multiple positioning convex blocks are used to locate the bottom of the reagent vial.

In accordance with various embodiments and aspects of the present disclosure, the bottom of the reagent vial is further provided with positioning cylinders that are matched with the positioning convex blocks.

In accordance with various embodiments and aspects of the present disclosure, the sealing structure includes a connector pin arranged on the end face of the testing box, a clamping groove arranged at the mouth of the piston cap, and a silicone gasket arranged between the testing box and the piston cap. The end of the connector pin is clamped in the clamping groove, and the connector pin runs through the silicone gasket.

In accordance with various embodiments and aspects of the present disclosure, the end of the connector pin is provided with a spherical part, which diameter is greater than the maximum diameter of the connector pin, and the end of the clamping groove is also provided with clamping protrusions. The distance between the two clamping protrusions is smaller than the diameter of the spherical part.

In accordance with various embodiments and aspects of the present disclosure, the beneficial effect of the integrated sampling sealed reagent box provided by the utility model is that, compared with the prior art, a piston cap is provided, which has a bearing-load chamber and fixes the reagent vial in the bearing chamber. The mouth of the reagent vial is lower than the opening of the piston cap, and a sealing structure is provided for connecting the testing box and the piston cap, This solves the problem of poor sealing between the contact part of the testing reagent box and the testing reagent vial, thus avoids the problems of gas leakage and easy leakage of reagents, protects testing staff, and avoids environmental damage.

### BRIEF DESCRIPTION OF THE DRAWINGS

In order to provide a clearer explanation of the technical solution in the embodiments of the present utility model, a brief introduction will be given to the accompanying drawings required in the embodiments or existing technical descriptions. It is evident that the accompanying drawings in the following description are only some embodiments of the present utility model. For average technicians in the field, other accompanying drawings can be obtained based on these drawings without creative effort.

FIG. 1 is a structural schematic diagram of the integrated sampling sealed reagent box provided in accordance with various embodiments and aspects of the present invention;

FIG. 2 is a schematic diagram of the partially enlarged structure at point A of FIG. 1 in accordance with various embodiments and aspects of the present invention;

FIG. 3 is a schematic diagram of the piston cap structure of the integrated sampling sealing reagent box in accordance with various embodiments and aspects of the present invention;

FIG. 4 is a schematic diagram of the reagent vial structure of the integrated sampling sealed reagent box provided in accordance with various embodiments and aspects of the present invention;

FIG. 5 is a schematic diagram of the installation structure of the piston cap and reagent vial of the integrated sampling sealed reagent box in accordance with various embodiments and aspects of the present invention;

Legend of the accompanying figures: 10. Testing box; 20. Sampling probe; 21. Main body; 22. Guide groove; 30. Piston cap; 31. Sealing structure; 311. Connector pin; 312. Clamping groove; 313. Silicone gasket; 32. Fixing structure; 321. Groove; 322. Auxiliary ribs; 33. Positioning protrusions; 40. Reagent vial; 41. Fixing blocks; 42. Positioning cylinders.

### DETAILED DESCRIPTION

Various inventive features are described below that can each be used independently of one another or in combination with other features. However, any single inventive feature may not address any of the problems discussed above or may only address one of the problems discussed above.

It is noted that, as used herein, the singular forms “a,” “an” and “the” include plural referents unless the context clearly dictates otherwise. Appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future. Furthermore, to the extent that the terms “including”, “includes”, “having”, “has”, “with”, or variants thereof are used in either the detailed description and the claims, such terms are intended to be inclusive in a similar manner to the term “comprising.”

The following describes various examples of the present technology that illustrate various aspects and embodiments of the invention. Generally, examples can use the described aspects in any combination. The description is not to be taken in a limiting sense, but it is made merely for the purpose of illustrating the general principles of the disclosure, since the scope of the disclosure is best defined by the appended claims. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

In order to make the technical problems, technical solutions, and beneficial effects to be solved by this utility model clearer, the following is a further detailed explanation of this utility model in conjunction with the accompanying figures and embodiments. It should be understood that the specific embodiments described here are only intended to explain the present utility model instead of limiting it.

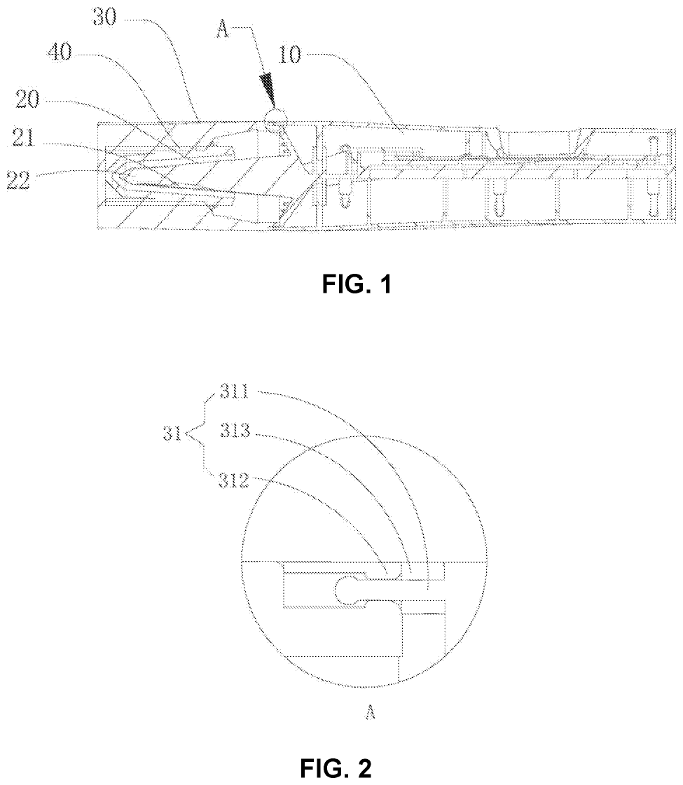

The integrated sampling sealed reagent box provided by this utility model is explained as follows, referring to FIGS. 1 and 2. An integrated sampling sealed reagent box, including a testing box 10, sampling probe 20, piston cap 30, and reagent vial 40. Testing box 10 is equipped with a test strip inside. The sampling probe 20 is set at the first end of the reagent box, including the main body part 21 and a guide groove 22 arranged on the main body part 21. The guide groove 22 is arranged along the length direction of the main body part 21. The piston cap 30 has a load-bearing chamber, and a sealing structure 31 is provided at the opening of the load-bearing chamber. The piston cap 30 is sealed and connected to the first end of the testing box 10 through the sealing structure 31. And reagent vial 40, located in the bearing chamber for containing testing reagents, is sealed with an aluminum film at the opening of the reagent vial 40, which is lower than the opening of the piston cap 30.

The integrated sampling sealed reagent box provided in this embodiment, compared with the prior art, is equipped with a piston cap 30, which has a load-bearing chamber and fixes the reagent vial 40 in the bearing chamber. The mouth of the reagent vial 40 is lower than the opening of the piston cap 30, and a sealing structure 31 is set to connect the testing box 10 and the piston cap 30, solving the problem of poor sealing at the contact part between the testing reagent box and the testing reagent vial 40, which avoids the problems of gas leakage and easy leakage of reagents, protects testing staff, and avoids environmental damage.

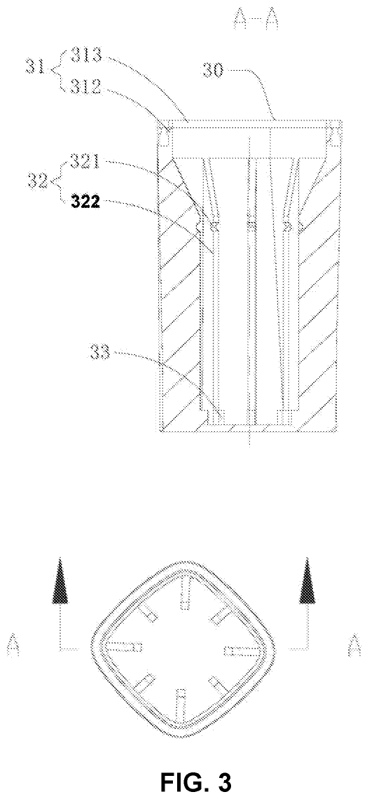

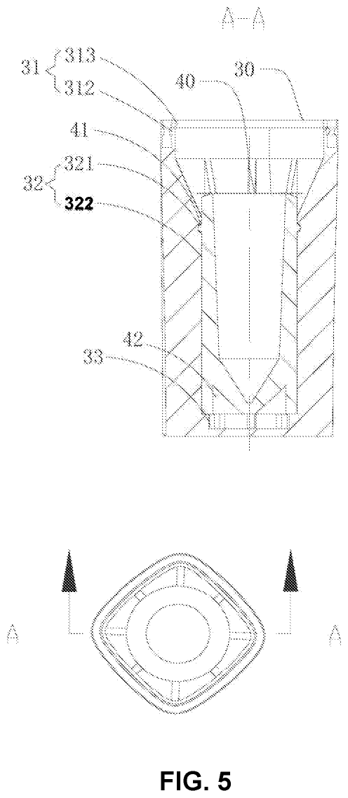

In some embodiments, the piston cap 30 can adopt the structure shown in FIGS. 3 and 5. As shown in FIGS. 3 and 5, a fixing structure 32 is installed on the inner wall of the load-bearing chamber, and the reagent vial 40 is clamped inside the piston cap 30 through the fixing structure 32. The fixing structure 32 forms a fixing position inside the piston cap 30, which is used to fix the position of the reagent vial 40 inside the piston cap 30. The reagent vial 40 is fixed in the middle position of the piston cap 30, allowing the sampling probe 20 to accurately enter the reagent vial 40, thus strengthening how they work together with sound practicality.

In some embodiments, the fixing structure 32 mentioned above can adopt the structure shown in FIGS. 3 and 5. Referring to FIGS. 3 and 5, the fixing structure 32 consists of multiple grooves 321 arranged inside the load-bearing chamber. The outer wall of the reagent vial 40 is uniformly fixed in a circular shape with fixing blocks 41. After the installation of the reagent vial 40, the fixing block 41 leans against the inside of the groove 321. The groove 321 can also be set along the depth direction of the vial body, corresponding to the fixing blocks 41 on the outer wall of the reagent vial 40, which is used to locate the position of the reagent vial 40 in the load-bearing chamber, with a simple structure and convenient installation.

In some embodiments, the load-bearing chamber can adopt the structure shown in FIGS. 3 and 5. As shown in FIGS. 3 and 5, multiple auxiliary ribs 322 are also arranged on the interior of the load-bearing chamber. The auxiliary ribs 322 are all arranged along the depth direction of the piston cap 30, and multiple auxiliary ribs 322 are arranged in a circular shape on the inner wall of the bearing chamber. Two adjacent auxiliary ribs 322 are spaced between each other, and the groove 321 corresponds to the auxiliary ribs 322-1 and are all located on the side of the auxiliary ribs 322. The auxiliary rib 322 can reduce the wall thickness of the piston cap 30, reduce costs, and reduce the weight of the integrated sampling sealing reagent box while completing positioning, with good practicality.

In some embodiments, the auxiliary ribs 322 can adopt the structure shown in FIGS. 3 and 5. As shown in FIGS. 3 and 5, the end of the auxiliary ribs 322 near the piston cap 30 is equipped with a guide slope, and at least three auxiliary ribs 322 are provided. The guide slope is used to provide guidance for the installation of reagent vial 40, facilitating alignment and installation. At least three auxiliary ribs 322 are provided to provide positioning for the installation of reagent vial 40.

In some embodiments, the above-mentioned auxiliary ribs 322 can adopt the structure shown in FIGS. 3 and 5. Referring to FIGS. 3 and 5, the other end of the auxiliary ribs 322 is also provided with positioning protrusions 33, which are located on the side of the auxiliary ribs 322 and extend towards the center of the load-bearing chamber. Multiple positioning protrusions 33 are used to locate the bottom of the reagent vial 40. The positioning convex blocks 33 has the same number as the auxiliary ribs 322, corresponding one by one to the auxiliary ribs 322, and are connected to the bottom of the piston cap 30 to form a positioning group, which is used to connect the reagent vial 40 and prevent it from rotating within the piston cap 30, with a simple structure and convenient processing.

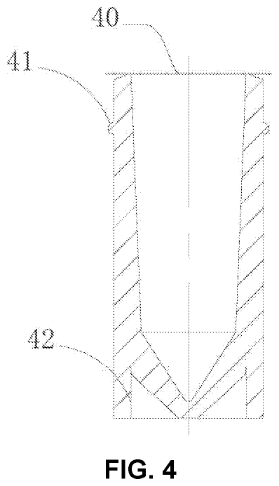

In some embodiments, the reagent vial 40 can adopt the structure shown in FIGS. 4 and 5. As shown in FIGS. 4 and 5, the bottom of reagent vial 40 is also equipped with positioning cylinders 42 that are matched with positioning convex blocks 33. The positioning cylinders 42 are a limit port at the bottom of the reagent vial 40, used for connecting onto the positioning convex blocks 33 for fixation, with a simple assembly method and high practicality.

In some embodiments, the sealing structure 31 mentioned above can adopt the structures shown in FIGS. 1 to 3 and 5. Referring to FIGS. 1 to 3 and 5, the sealing structure 31 includes a connector pin 311 arranged on the end surface of the testing box 10, a clamping groove 312 arranged at the mouth of the piston cap 30, and a silicone gasket 313 arranged between the testing box 10 and the piston cap 30. The end of the connector pin 311 is clamped in the clamping groove 312, and the connector pin 311 runs through the silicone gasket. The connector pin 311 is uniformly arranged on the end face of the testing box 10 in a circular shape, corresponding to the clamping groove 312-1 uniformly arranged at the mouth of the piston cap 30. Multiple connector pins 311 and clamping grooves 312 can be arranged in, and where they are connector ring and clamping groove 312, two parallel silicone gaskets 313 with different diameters are sleeved on the connector ring to achieve sealing, with a simple structure and good sealing performance.

In accordance with various embodiments and aspects of the invention, the sealing structure 31 mentioned above can adopt the structures shown in FIGS. 1 to 3 and 5. As shown in FIGS. 1 to 3 and 5, the end of the connector pin 311 is equipped with a spherical part, with a diameter greater than the maximum diameter of the connector pin 311. The end of the clamping groove 312 is also equipped with clamping protrusions, and the distance between two clamping protrusions is smaller than the diameter of the spherical part. The connector pin 311 and the clamping groove 312 are both made of plastic material, which has a certain degree of elasticity and can achieve a certain degree of elastic deformation. They are easy to make and low in cost.

The above are only some preferred embodiments of this utility model and are not intended to present any limitation. Any modifications, equivalent replacements, and improvements made within the spirit and principles of this utility model should be included in the scope of protection of this utility model. Certain examples have been described herein and it will be noted that different combinations of different components from different examples may be possible. Salient features are presented to better explain examples; however, it is clear that certain features may be added, modified and/or omitted without modifying the functional aspects of these examples as described.

It should be understood, of course, that the foregoing relates to exemplary embodiments of the invention and that modifications may be made without departing from the scope of the invention. The scope of the invention, therefore, is not intended to be limited to the exemplary embodiments shown and described herein. Rather, the scope and spirit of present invention is embodied by the appended claims.

What is claimed is:

1. An integrated sampling sealed reagent box comprising:
a testing box having a test strip inside;
a sampling probe arranged at a first end of the reagent box, including a main body part and a guide groove arranged on the main body part, wherein the guide groove is arranged along a length direction of the main body part;
a piston cap equipped with a load-bearing chamber and a sealing structure at an opening of the load-bearing chamber, wherein the piston cap is sealed and connected to the first end of the testing box through the sealing structure; and
a reagent vial located in the load-bearing chamber for containing testing reagents, wherein the reagent vial is sealed with an aluminum film at a vial mouth of the reagent vial and the vial mouth is lower than the opening of the piston cap.

2. The integrated sampling sealed reagent box of claim 1, wherein a fixing structure is arranged on an inner wall of the load-bearing chamber and the reagent vial is clamped inside the piston cap through the fixing structure.

3. The integrated sampling sealed reagent box of claim 2, wherein the fixing structure includes grooves that are arranged inside the load-bearing chamber and an outer wall of the reagent vial is uniformly fixed in a circular shape with fixing blocks, wherein after the reagent vial is installed, the fixing blocks rest against the inside of the grooves.

4. The integrated sampling sealed reagent box of claim 3, wherein there are multiple auxiliary ribs arranged on an interior of the load-bearing chamber, all of which are arranged along a depth direction of the piston cap and multiple auxiliary ribs are arranged in a circular shape on the inner wall of the load-bearing chamber with spacing between two adjacent auxiliary ribs, wherein the grooves correspond to the auxiliary ribs and are located on a side of the auxiliary ribs.

5. The integrated sampling sealed reagent box of claim 4, wherein one end of an auxiliary rib, which is selected from the multiple auxiliary ribs, near the piston cap opening is provided with a guide slope, and at least three auxiliary ribs are provided.

6. The integrated sampling sealed reagent box of claim 5, wherein another end of the auxiliary ribs includes positioning convex blocks, which are located on the side of the auxiliary ribs and extend towards a center of the load-bearing chamber and multiple positioning convex blocks are used to locate a bottom of the reagent vial.

7. The integrated sampling sealed reagent box of claim 6, wherein the bottom of the reagent vial is also equipped with positioning cylinders that are matched with the positioning convex blocks.

8. The integrated sampling sealed reagent box of claim 1, wherein the sealing structure includes a connector pin arranged on an end face of the testing box, wherein a clamping groove is arranged at the mouth of the piston cap, and wherein a silicone gasket is arranged between the testing box and the piston cap, such that an end of the connector pin is clamped in the clamping groove and the connector pin runs through the silicone gasket.

9. The integrated sampling sealed reagent box of claim 8, wherein the end of the connector pin includes a spherical part and a diameter of the spherical part is greater than a maximum diameter of the connector pin, such that the end of the clamping groove includes clamping protrusions and a distance between at least two clamping protrusions is less than the diameter of the spherical part.
